(19) United States
(12) Patent Application Publication
(10) Pub. No.: US 2025/0216752 A1
(43) Pub. Date: Jul. 3, 2025

(54) Center Shaft of Photographic Tripod

(71) Applicant: PGYTECH CO.,LTD, Jiangsu (CN)

(72) Inventors: Meng ZHANG, Jiangsu (CN); Shilei ZHU, Jiangsu (CN); Bingchao XIA, Jiangsu (CN)

(73) Assignee: PGYTECH CO.,LTD, Jiangsu (CN)

(21) Appl. No.: 19/001,911

(22) Filed: Dec. 26, 2024

(30) Foreign Application Priority Data
Dec. 29, 2023 (CN) 202323657409.4
Jan. 23, 2024 (CN) 202420161667.9

(51) Int. Cl. G03B 17/56; F16M 11/24; F16M 11/28

(52) U.S. Cl. CPC G03B 17/561; F16M 11/242; F16M 11/28; F16M 2200/025

(57) ABSTRACT

The present disclosure provides a center shaft of a photographic tripod, including a first shaft segment and a second shaft segment which are detachably connected. The first shaft segment has a clamping portion, the second shaft segment has a locking shaft which can be inserted into the first shaft segment, an end of the locking shaft has a buckle block, and the buckle block and the clamping portion are clamped to lock the first shaft segment and the second shaft segment together. The second shaft segment further includes a locking member, and the locking member holds, in a locked state, the locking shaft in a position of being locked together with the first shaft segment.

### CROSS-REFERENCE TO RELATED APPLICATIONS

The present application claims priority to Chinese Patent Application No. 202323657409.4, filed on Dec. 29, 2023, entitled “QUICK DETACHING MECHANISM OF CENTER SHAFT OF PHOTOGRAPHIC TRIPOD”, the content of which and its modifications are incorporated herein by reference in its entirety.

The present application claims priority to Chinese Patent Application No. 202420161667.9, filed on Jan. 23, 2024, entitled “UNLOCKING ASSEMBLY FOR ADJUSTING MEMBER AND PHOTOGRAPHIC TRIPOD CONTAINING ASSEMBLY”, the content of which and its modifications are incorporated herein by reference in its entirety.

### TECHNICAL FIELD

The present disclosure relates to the technical field of photographic tripods, in particular to a center shaft of a photographic tripod.

### BACKGROUND

Photographic scaffolding, i.e. a tripod, is a support frame used to stabilize a camera, plays an important role in photography and videography, and can help a photographer to achieve a desired photographic effect.

In order to meet different shooting needs and changes in viewing angle, it is often necessary to adjust a height of the photographic tripod. The photographer may adjust the height of the tripod and thus adjust an angle and height of the camera according to a shooting theme and compositional needs, so as to obtain a more satisfactory shooting effect. For example, when a landscape or a building is photographed, it may be necessary to place the camera in a lower position to obtain a wider viewing angle, while when a portrait is photographed or during macro photography, it may be necessary to place the camera in a higher position to obtain better composition and viewing angle. Therefore, a height adjustment is very important for the photographer, and it can help the photographer to better grasp the initiative of shooting and obtain a better shooting effect.

Therefore, a central shaft of the photographic tripod may also be adjusted up and down usually when the tripod is fully open. There are various ways to adjust the center shaft up and down, and one of them is to arrange the center shaft into a plurality of segments that may be extended and retracted for storage. However, in some cases, even if the plurality of segments of the center shaft are all retracted for storage to a smallest position, it still cannot meet the needs of low-position shooting, and then it is necessary to detach one or more segments of the center shaft at this point. However, the detachment and installation of the multi-segment center shaft in the prior art usually cannot realize quick detachment, and a tool is required to perform the detachment and installation, which is inconvenient to operate and affects the experience of a user.

### SUMMARY

The present disclosure provides a center shaft of a photographic tripod to solve the problems proposed by the above background.

In order to implement the above inventive objective, the present disclosure adopts the following technical solutions.

A center shaft of a photographic tripod includes a first shaft segment and a second shaft segment which are detachably connected. The first shaft segment has a clamping portion, the second shaft segment has a locking shaft which can be inserted into the first shaft segment, an end of the locking shaft has a buckle block, and the buckle block and the clamping portion are clamped to lock the first shaft segment and the second shaft segment together. The second shaft segment further includes a locking member, and the locking member holds, in a locked state, the locking shaft in a position of being locked together with the first shaft segment.

The present disclosure further provides a center shaft of a photographic tripod, including a first shaft segment and a second shaft segment which are detachably connected, and a quick detaching mechanism is arranged between the first shaft segment and the second shaft segment. The quick detaching mechanism includes a clamping portion formed in the first shaft segment, and a locking shaft arranged on the second shaft segment, and the locking shaft can be inserted into the first shaft segment. An end of the locking shaft has a buckle block, and the buckle block and the clamping portion are clamped to lock the first shaft segment and the second shaft segment together. One end of the first shaft segment or the second shaft segment away from the quick detaching mechanism is provided with an adjusting member, the adjusting member is provided with an unlocking assembly, and the unlocking assembly is configured to unlock the adjusting member from the first shaft segment or the second shaft segment.

### BRIEF DESCRIPTION OF DRAWINGS

Accompanying drawings of the specification, which form part of the present application, are used to provide a further understanding of the present disclosure, and schematic embodiments of the present disclosure and the description thereof are used to explain the present disclosure and do not constitute an improper limitation of the present disclosure. In the accompanying drawings:

FIG. 1 is a schematic structural diagram of the present disclosure a whole.

FIG. 2 illustrates a schematic diagram of a split structure of a quick detaching mechanism of a center shaft of FIG. 1.

FIG. 3 illustrates a schematic exploded diagram of a quick detaching mechanism of a center shaft of FIG. 1.

FIG. 4 illustrates a schematic structural diagram of another embodiment of a first shaft segment of a quick detaching mechanism of a center shaft of FIG. 1.

FIG. 5 illustrates a section view of a first shaft segment in FIG. 4.

FIG. 6 illustrates a schematic diagram of a quick detaching mechanism of a center shaft of FIG. 1 before locking.

FIG. 7 illustrates a section view of a quick detaching mechanism of a center shaft of FIG. 6 before locking.

FIG. 8 illustrates a section view of a quick detaching mechanism of a center shaft of FIG. 1 after locking.

FIG. 9 illustrates a schematic structural diagram of a bottom of a second shaft segment in FIG. 1.

FIG. 10 illustrates a schematic split diagram of an adjusting member of a quick detaching mechanism of a center shaft of FIG. 1.

FIG. 11 illustrates a schematic structural diagram of an adjusting member in FIG. 10.

FIG. 12 illustrates a schematic exploded diagram of an adjusting member in FIG. 11.

FIG. 13 illustrates a section view of a quick detaching mechanism of a center shaft installing an adjusting member of FIG. 10.

FIG. 14 illustrates a schematic structural diagram of a body of an adjusting member in FIG. 11.

FIG. 15 illustrates a schematic structural diagram of a body of an adjusting member in FIG. 11 in another viewing angle.

FIG. 16 illustrates a schematic structural diagram of a body of an adjusting member installing a connecting member in FIG. 11.

FIG. 17 illustrates a schematic structural diagram of another embodiment of a second shaft segment of a quick detaching mechanism of a center shaft of FIG. 1.

Reference numerals: 1, first shaft segment; 11, first outer tube; 12, first liner member; 121, clamping portion; 2, second shaft segment; 21, second outer tube; 211, groove; 22, second liner member; 231, locking shaft; 2311, buckle block; 232, locking member; 233, swivel pin; 24, cavity; 3, unlocking assembly; 31, adjusting member; 311, adjusting member upper portion; 312, connecting plate; 313, adjusting member lower portion; 314, assembly portion; 3141, accommodation cavity; 3142, sliding block; 32, body; 321, assembly cavity; 322, step-shaped structure; 323, locking cavity; 324, rotary sliding rail; 325, moving rail; 326, bearing platform; 327, first vertical rail; 33, connecting member; 331, bearing ring; 332, locking block; 333, clamping portion; 334, second vertical sliding rail; 34, assembly member; 35, reset assembly; and 36, cover plate.

### DESCRIPTION OF EMBODIMENTS

Technical solutions in embodiments of the present disclosure will be clearly and completely described below in conjunction with accompanying drawings in the embodiments of the present disclosure. Obviously, the described embodiments are part of the embodiments of the present disclosure, not all of them. The following description of at least one exemplary embodiment is in fact illustrative and in no way serves as any limitation of the present disclosure and its application or use. Based on the embodiments in the present disclosure, all other embodiments obtained by those of ordinary skill in the art without creative work shall fall within the protection scope of the present disclosure.

It needs to be noted that terms used herein are intended only to describe specific implementations and are not intended to limit exemplary implementations according to the present application. As used here, a singular form is also intended to include a plural form, unless the context clearly indicates otherwise. In addition, it should be understood that when terms “contain” and/or “include” are used in this specification, they indicate the presence of features, steps, operations, devices, components, and/or combinations thereof.

Unless otherwise specifically indicated, the relative arrangements, numerical expressions and values of the components and steps set forth in these embodiments do not limit the scope of the present disclosure. At the same time, it should be understood that, for ease of description, the dimensions of the various parts shown in the accompanying drawings are not drawn in an actual proportional relationship. Technologies, methods, and devices known to those of ordinary skill in the related field may not be discussed in detail, but where appropriate, said technologies, methods, and devices should be considered as part of the authorized specification. In all of the examples shown and discussed herein, any specific values should be interpreted as exemplary and not as limitations. Thus, other examples of exemplary embodiments may have different values. It should be noted that similar numerals and letters represent similar items in the following accompanying drawings. Therefore, once an item is defined in an accompanying drawing, it does not need to be further discussed in subsequent accompanying drawings.

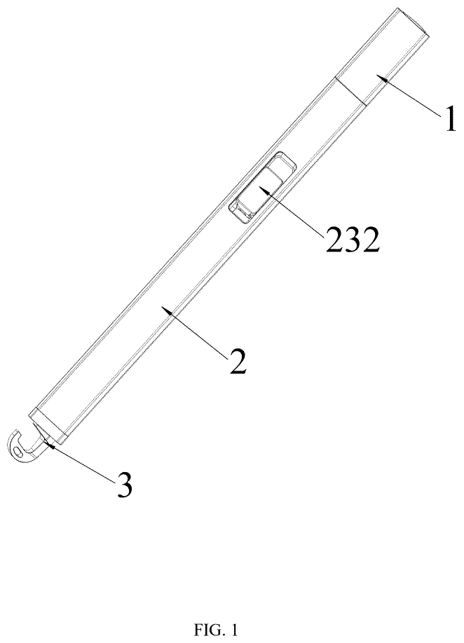

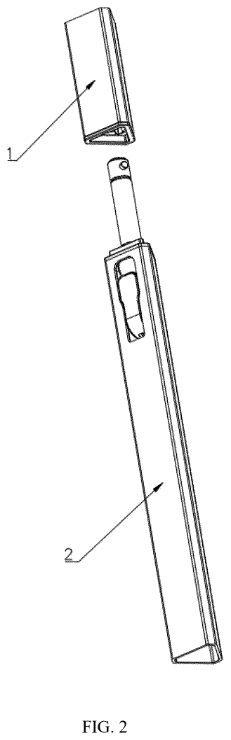

As shown in FIG. 1-FIG. 17, a center shaft of a photographic tripod includes a first shaft segment 1 and a second shaft segment 2 which are detachably connected. The first shaft segment 1 has clamping portions 121, the second shaft segment 2 has a locking shaft 231 which can be inserted into the first shaft segment 1, an end of the locking shaft 231 has a buckle block 2311, and the buckle block 2311 and the clamping portions 121 are clamped to lock the first shaft segment 1 and the second shaft segment 2 together. The second shaft segment 2 further includes a locking member 232, and the locking member 232 holds, in a locked state, the locking shaft 231 in a position of being locked together with the first shaft segment 1. The above locking member 232 may be a wrench or a knob. Preferably, the wrench is used for a square tube, and the knob may be used in a case of a circular tube.

The center shaft of the photographic tripod provided by the present disclosure may realize rapid detachment and installation, at the same time, the first shaft segment 1 and the second shaft segment 2 are firmly locked by the locking member 232 in the locked state, and thus the stability and reliability of the connection may be ensured. In this embodiment, the locking member 232 may be a locking wrench or a locking knob, e.g., the locking wrench is preferred when used for a block structure, while the locking knob is preferred when used for a structure such as a tube.

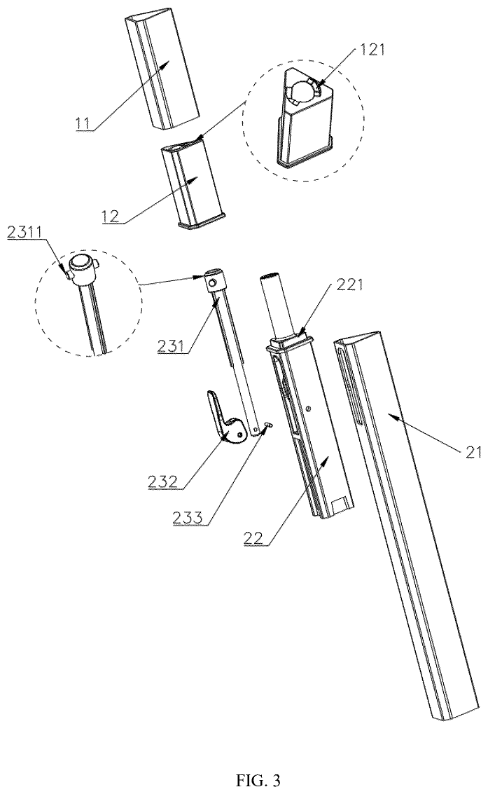

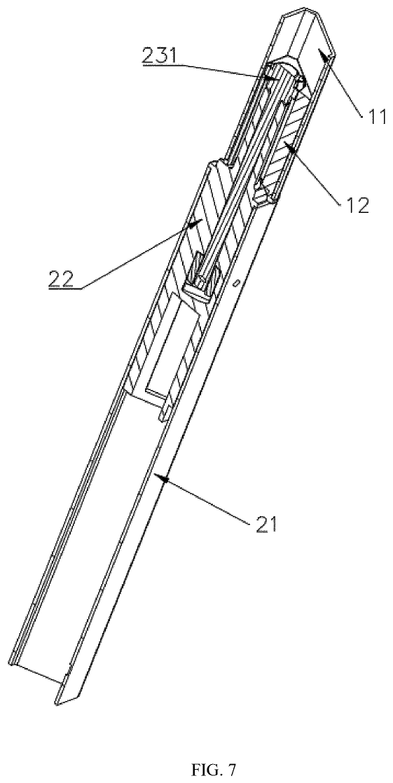

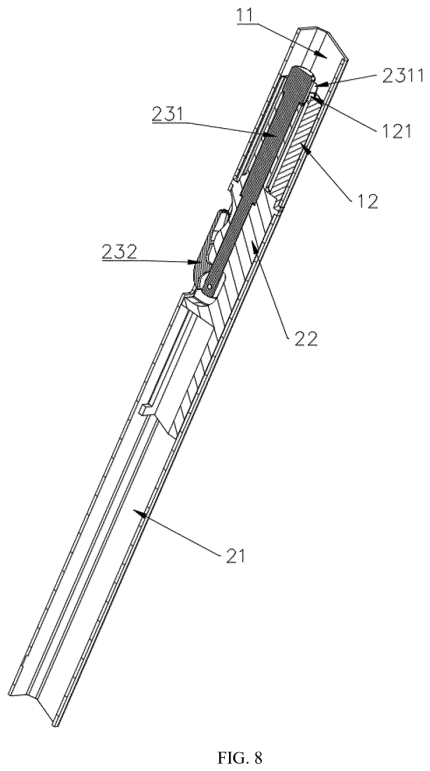

Please refer to FIG. 3, FIG. 7 and FIG. 8, and in this embodiment, the first shaft segment 1 includes a first outer tube 11 and a first liner member 12 fixed in the first outer tube 11, wherein the clamping portions 121 are formed in the first liner member 12. The first outer tube 11 may be made of a metal material (e.g., stainless steel or aluminum alloy) having good corrosion resistance and high hardness, and the first liner member 12 may be made of a plastic material (e.g., PEEK or PC) having high wear resistance. The metal member has high strength and is not prone to damage. Structures such as the clamping portions 121 are easy to process with the plastic member so as to facilitate the fit with the locking shaft 231.

The clamping portions 121 are arranged on a top end face of the first liner member 12. In this embodiment, as shown in FIG. 3, each clamping portion is a groove, and a bottom face of each clamping portion 121 is a bevel which gradually rises from bottom to top in a clamping direction, so that it may be realized that the first shaft segment 1 and the second shaft segment 2 are pulled tightly together in a process of locking the locking shaft 231 and the first liner member 12, to ensure the reliability and stability of the connection. In this embodiment, there are two clamping portions 121 provided, and the two clamping portions 121 are arranged centrally symmetrically.

In other embodiments (not shown in the figures), the two clamping portions 121 may also be arranged asymmetrically, the number of the clamping portions 121 may also be three, and three clamping portions 121 may make the connection more secure and less prone to shaking. Please continue to refer to FIG. 3, FIG. 7, and FIG. 8, the second shaft segment 2 includes a second outer tube 21 and a second liner member 22 fixed in the second outer tube 21, and the locking shaft 231 penetrates in the second liner member 22. The second outer tube 21 may be made of a metal material (e.g., stainless steel or aluminum alloy) having good corrosion resistance and high hardness, and the second liner member 22 may be made of a plastic material (e.g., PEEK or PC) having high wear resistance. The metal member has high strength and is not prone to damage. Structures such as a hole for penetration of the locking shaft 231 are easily molded in the plastic member, and wear with the locking shaft 231 can be reduced.

The locking shaft 231 can be slidably installed in the second liner member 22 in an axial direction of the locking shaft. One end of the locking shaft 231 towards the first shaft segment 1 is provided with buckle blocks 2311, and in this embodiment, the buckle blocks 2311 are cylindrical projections arranged at the end of the locking shaft 231. There are two buckle blocks 2311, and they are arranged centrally symmetrically. One end of the locking member 232 is pivotally connected to one end of the locking shaft 231 away from the buckle blocks 2311 through a swivel pin 233. An extending direction of the swivel pin 233 is a radial direction of the locking shaft 231, the end of the locking member 232 connected to the swivel pin 233 is provided with a convex portion, and the locking member 232 may rotate around the swivel pin 233 to switch between a locked state and an unlocked state. In other embodiments (not shown in the figures), the number of the buckle blocks 2311 may be three corresponding to the number of the clamping portions 121, and the buckle blocks 2311 may also be in other geometric shapes such as rectangular projections and polygonal projections.

In other embodiments (not shown in the figures), the buckle blocks 2311 may also be V-shaped spring-leaf buckles or buckles in forms such as marble buckles, the V-shaped spring-leaf buckles realize tight buckling by elastic compression force, and the marble buckles realize locking by means of embedded marbles. The design of the marble buckles is simple and efficient, and when the marble buckles right faces the clamping portion 121, the marbles are automatically clamped into the clamping portion 121 to form firm clamping.

Further, an end of the second liner member 22 towards the first shaft segment 1 is provided with a boss, and a lower end of the first liner member 12 is arranged as a sleeving opening for sleeving with the boss. In this example, the sleeving opening and the boss are in a shape of a triangle, and by the fit of the sleeving opening and the boss, it is possible to prevent a case that a rotation between the first shaft segment 1 and the second shaft segment 2 due to shaking or an external force releases the clamping connection between the buckle blocks 2311 and the clamping portions 121. Thus, in a case where the locking member 232 is released from the locked state, the first shaft segment 1 is separated in the axial direction of the shaft segments while rotating relative to the second shaft segment 2, and then the locking can be released.

In other embodiments (not shown in the figures), the shape of the sleeving opening and the boss may be a geometric shape such as a rectangle and a polygon.

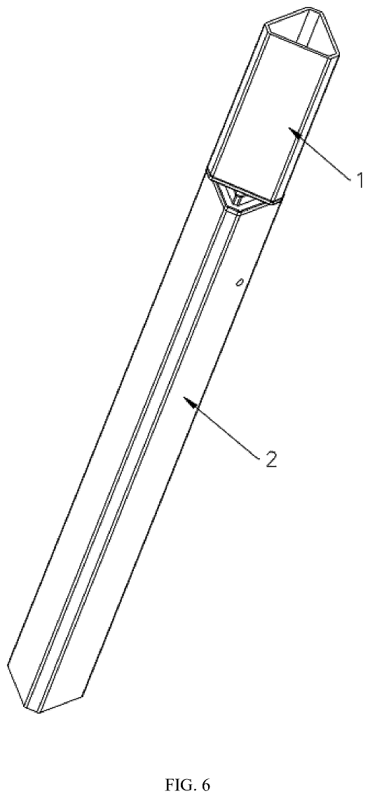

Further, please refer to FIG. 1, FIG. 6 and FIG. 8, in this embodiment, the first shaft segment 1 and the second shaft segment 2 are both in a shape of a triangular prism, wherein in an unlocked state of the first shaft segment 1 and the second shaft segment 2, side faces of the first shaft segment 1 and the second shaft segment 2 are misaligned, and in a locked state of the first shaft segment 1 and the second shaft segment 2, the side faces of the first shaft segment 1 and the second shaft segment 2 are aligned. Such an arrangement allows a visual and easy way to know the state of locking or not between the first shaft segment 1 and the second shaft segment 2.

In other embodiments (not shown in the figures), they may also be in other polyhedral shapes or other geometric shapes such as a circle.

In use, the locking shaft 231 of the second shaft segment 2 is inserted into the first shaft segment 1 and rotated at a certain angle so that the buckle blocks 2311 at the end of the locking shaft 231 climb into the clamping portions 121 as gradually rising bevels on the first liner member 12 of the first shaft segment 1. In this process, the first shaft segment 1 is pulled downwards tightly to fit closely with the second shaft segment 2, and after buckling is completed, the locking member 232 is fastened to realize the locking of the upper and lower shaft segments. When it is necessary to detach the first shaft segment 1 and the second shaft segment 2, the locking member 232 is first released, then the first shaft segment 1 is rotated in a reverse direction so that the buckle blocks 2311 at the end of the locking shaft 231 are rotated out of the clamping portions 121 on the first liner member 12 of the first shaft segment 1, and thus the first shaft segment 1 may be pulled away from the second shaft segment 2 and separated while being rotated.

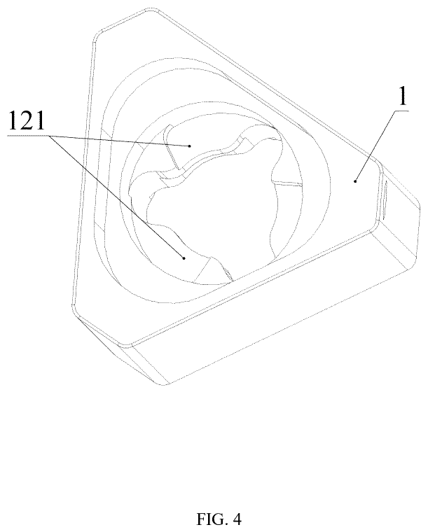

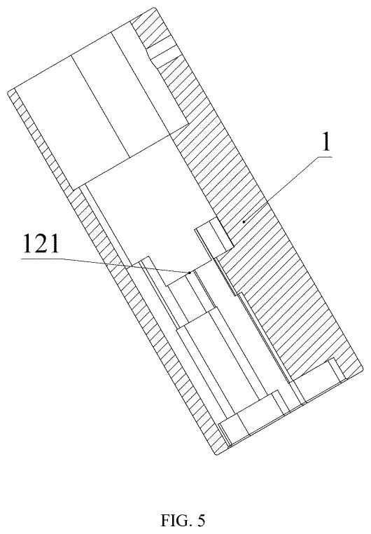

In another embodiment, please refer to FIG. 4 and FIG. 5, this embodiment differs from the embodiment above in that a first shaft segment 1 may not be provided with a first liner member 12, clamping portions 121 are formed in the first shaft segment 1, and the clamping portions 121 are planes; and an integrated structure makes it possible to reduce processing and manufacturing costs and assembly steps, and the risk of malfunction due to improper assembly or loosening of parts is also reduced, making the structure simpler and improving reliability.

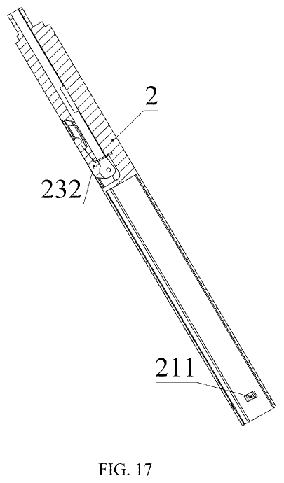

In another embodiment, please refer to FIG. 17, this embodiment differs from the embodiment above in that a second shaft segment 2 may not be provided with a second liner member 22, a locking shaft 231 directly penetrates in the second shaft segment 2, an integrated structure makes it possible to reduce processing and manufacturing costs and assembly steps, and the risk of malfunction due to improper assembly or loosening of parts is also reduced, making the structure simpler and improving reliability.

As may be seen from the above description of the specific embodiments, in the quick detaching mechanism of the center shaft of the photographic tripod provided by the present disclosure, the first shaft segment 1 thereof has the clamping portions 121, the second shaft segment 2 has the locking shaft 231 which can be inserted into the first shaft segment 1, the end of the locking shaft 231 has the buckle blocks 2311, and the buckle blocks 2311 and the clamping portions 121 are clamped to lock the first shaft segment 1 and the second shaft segment together 2. The second shaft segment 2 further includes a locking member 232, and the locking member 232 holds, in a locked state, the locking shaft 231 in a position of being locked together with the first shaft segment 1. The quick detaching mechanism may realize quick detachment and installation, at the same time, the first shaft segment 1 and the second shaft segment 2 are firmly locked by the locking member 232 in the locked state, and thus the stability and reliability of the connection may be ensured.

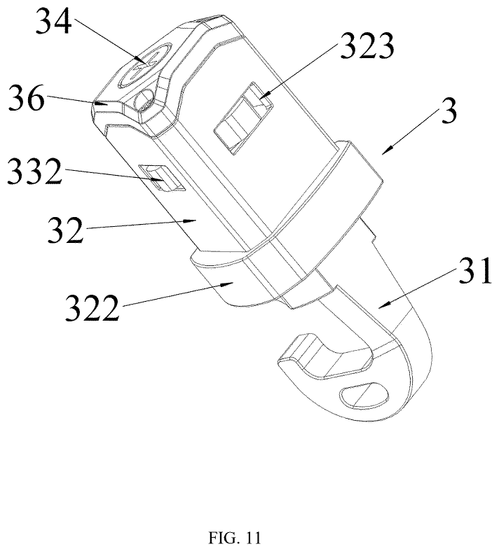

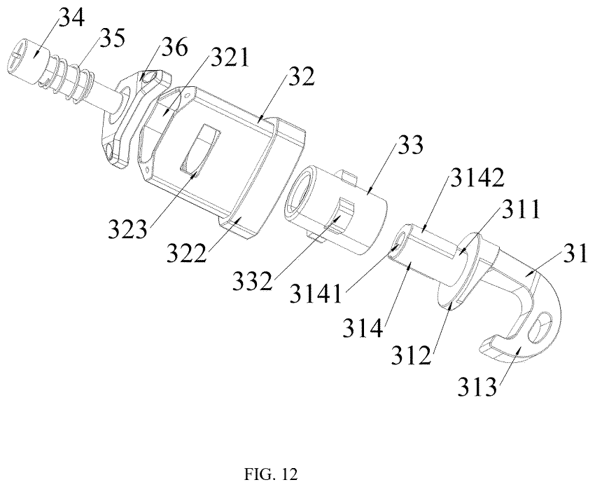

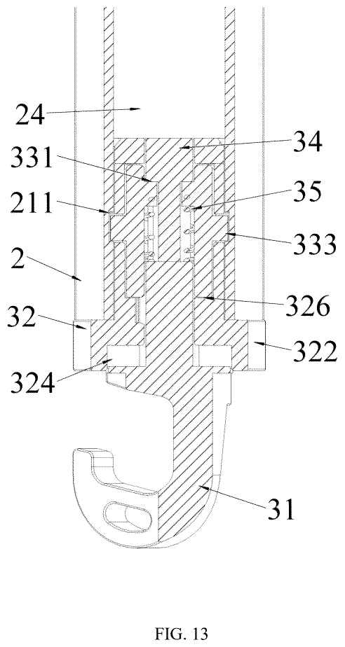

Please refer to FIG. 1, FIG. 11, FIG. 12 and FIG. 13, in this embodiment, one end of the second shaft segment 2 away from the quick detaching mechanism is provided with an adjusting member 31, the adjusting member 31 is provided with an unlocking assembly 3, and the unlocking assembly 3 is configured to unlock the adjusting member 31 from the second shaft segment 2. In this embodiment, a structure such as a hook or loop is molded on the adjusting member 31.

The second shaft segment 2 internally has a cavity 24; and the unlocking assembly includes a body 32 having an assembly cavity 321, and a connecting member 33 located in the assembly cavity 321, and the connecting member 33 is clamped in the cavity 24 after partially extending out of the assembly cavity 321.

In other embodiments (not shown in the figures), the adjusting member 31 may be arranged at an end of the first shaft segment 1 away from the quick detaching mechanism, the first shaft segment 1 internally has a cavity 24, and the unlocking assembly 3 is clamped in the cavity 24 of the first shaft segment 1.

Please refer to FIG. 13-FIG. 16, in this embodiment, in order to ensure adjustment after the connection, a rotary sliding rail 324 is arranged in the body 32, and a moving rail 325 extends inwards to form a bearing platform 326 of the connecting member 33. Then the connecting member 33 has a certain bearing and stress face when moving in a vertical direction.

The assembly member, such as a bolt, has certain gravity when connected to the adjusting member 31. At this time, the inner wall of the connecting member 33 extends inwards to form a bearing ring 331 of a bolt nut (i.e., a head of the assembly member), which will move upwards when the adjusting member 31 is pressed, at this time, the assembly member in the body 32 connected thereto will move upwards away from the bearing ring 331, and the cover plate has a very good limiting effect at this time. In order to realize the later reset, in this embodiment, a reset assembly 35 is arranged on a screw of the bolt in a sleeving mode, when pressing and the rotation are finished, the reset assembly 35 is compressed, the pressing force is released, and the reset assembly 35 is reset, so that the whole of the adjusting member 31, the body 32, the connecting member 33, etc. move downwards, and are removed from the second shaft segment 2. In this embodiment, the reset assembly 35 is a reset spring.

In other embodiments of the reset assembly 35 (not shown in the figures), the reset assembly 35 may also be replaced by other elastic parts, such as a spring sheet and a rubber pad as the reset assembly 35, and an appropriate elastic part may be selected to realize a reset function according to specific application scenarios and needs.

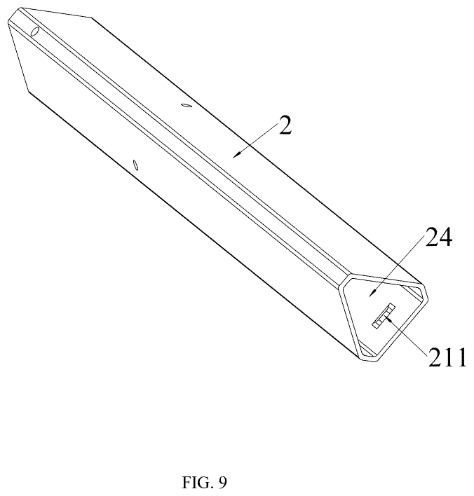

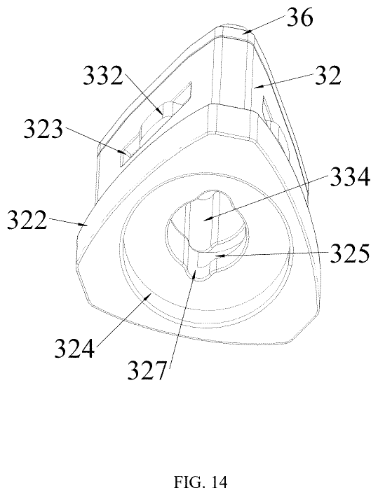

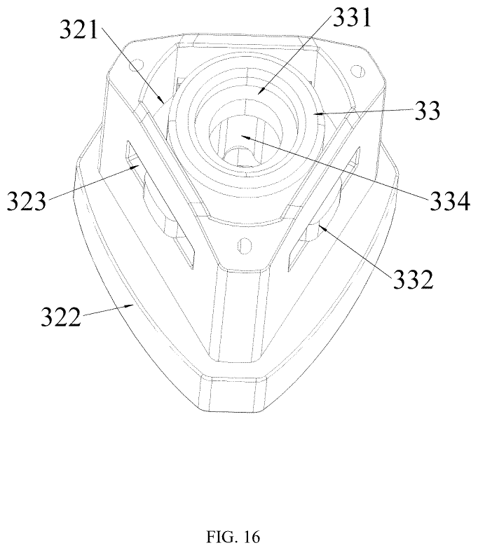

Please refer to FIG. 11, FIG. 13, FIG. 14, and FIG. 16, in this embodiment, when the adjusting member 31 is in a set position of the assembly cavity 321, the connecting member 33 is locked on the second shaft segment 2, when the adjusting member 31 is forced out of the set position, the adjusting member 31 and the connecting member 33 enter the rotary sliding rail 324 of the assembly cavity 321, the adjusting member 31 is rotated, the connecting member 33 is driven to rotate along the assembly cavity 321, and thus the body 32, the connecting member 33, and the adjusting member 31 are removed from the second shaft segment 2 to complete unlocking. In actual use, a fixing or locking position is generally arranged in the second shaft segment 2, at which time the fixing or locking position is the set position in this embodiment, and the position may be adjusted in the second shaft segment 2 according to the adjustment of the application scenario and the like. Please refer to FIG. 9, FIG. 12, and FIG. 13, in this embodiment, an inner wall of the cavity 24 of the second shaft segment 2 is provided with a groove 211, then the connecting member 33 is provided with a locking block 332 matched thereto, and the locking block 332 has a clamping portion 333. When the adjusting member 31 in the unlocking assembly of the entire adjusting member 31 is pressed, the clamping portion 333 is made to enter a position at the same height and misalignment as the groove 211, and then is rotated in a horizontal direction, at which time the clamping portion 333 is rotated horizontally to enter or move out of the groove 211, realizing the locking and unlocking with the second shaft segment 2. In this embodiment, the rotary sliding rail 324 is matched with a bottom of the body 32, which in turn adjusts the rotation of the body 32 and drives it to rotate for unlocking.

In order to facilitate the connection between the body 32 and the adjusting member 31, an assembly member 34 is further arranged, at which time the assembly member 34 is connected to the adjusting member 31 after entering through the body 32, and then a cover plate 36 is arranged above to realize the top limit of the assembly member 34. In this embodiment, the assembly member 34 may be a bolt, step shaft riveting or adhesive, etc., which in turn allows the body 32 to complete the initial connection with the adjusting member 31.

Please refer to FIG. 12-FIG. 14, in this embodiment, the adjusting member 31 specifically includes three parts, an adjusting member upper portion 311, an adjusting member lower portion 313, and a connecting plate 312 connecting the two, and after pressing, specifically, the connecting plate 312 enters the rotary sliding rail 324 formed below the body 32 to provide a basis for the subsequent use.

Specifically, an assembly portion 314 with an accommodation cavity 3141 is formed on the adjusting member upper portion, and a sliding block 3142 is formed on a periphery of the assembly portion 314. Since in pressing and resetting, there will be some movement in the vertical direction, the connecting member 33 forms a first vertical sliding rail 327 and a second vertical sliding rail 334 in the body 32, and the first vertical sliding rail 327 and the second vertical sliding rail 334 are configured for the up and down movement of the adjusting member 31. As the connecting plate enters the rotary sliding rail 324, the sliding block moves along the second vertical sliding rail 334 of the connecting member 33 or the first vertical sliding rail 327 in the body 32. In this embodiment, the first vertical sliding rail 327 in the body 32 is arranged to limit the connecting member 33 to not being able to rotate, at which time the sliding block of the adjusting member 31 is on both the first vertical sliding rail 327 of the body 32 and the second vertical sliding rail 334 of the connecting member 33, and thus at this time, by limiting the adjusting member 31 to not being able to rotate, the rotation of the connecting member 33 is limited. Once the possible movement in the vertical direction occurs, the adjusting member 31 moves along the second vertical sliding rail 334 in the connecting member 33, and the connecting member 33 moves along the first vertical sliding rail 327 in the body 32. In this embodiment, the purpose of the second vertical sliding rail 334 is to prevent the connecting member 33 from rotating without a force on the assembly cavity 321, and the second vertical sliding rail 334 is arranged in the connecting member 33, which serves to ensure that when a vertical left-right force is applied to the adjusting member 31, the adjusting member 31 may move up and down on the connecting member 33, and when a rotational force is applied, the connecting member 33 is driven to rotate.

In order to facilitate entering the rotary sliding rail 324, a lower part of the assembly cavity 321 on the body 32 extends outwards to form a step-shaped structure 322, and the rotary sliding rail 324 is formed in the step-shaped structure 322.

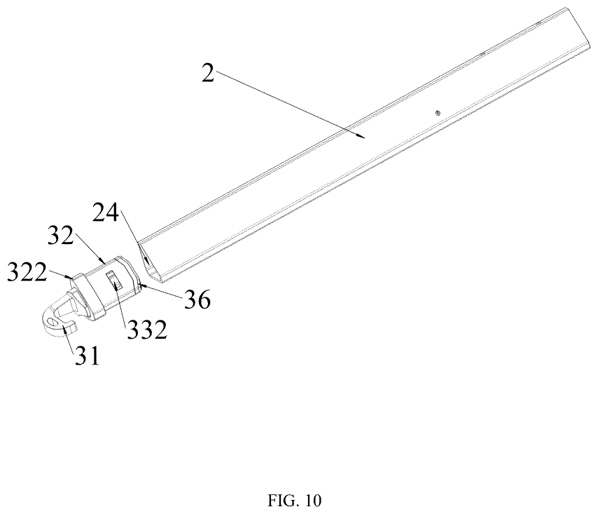

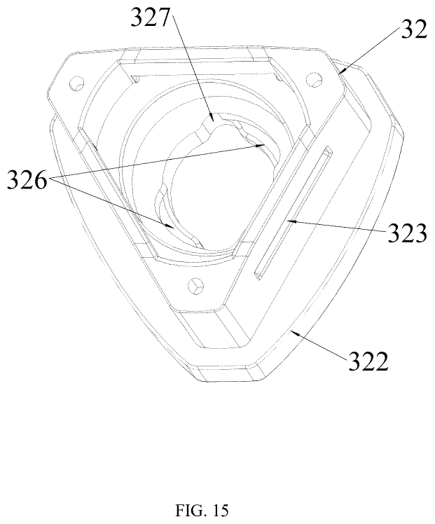

Please refer to FIG. 10, FIG. 11, and FIG. 15, in this embodiment, in performing the assembly of the body 32 and the connecting member 33, a locking cavity 323 is arranged at a set position of the inner wall of the assembly cavity 321 of the body 32, and a locking block 332 matched thereto is arranged on an outer side of the connecting member 33. Thus, in rotation, locking and unlocking of the locking cavity 323 and the locking block 332 may be realized, while in pressing stress, only the assembly member 34 and the adjusting member 31 may synchronously move up and down in the body 32 as well as in the connecting member 33.

In summary, as may be seen from the above description, the present disclosure realizes the following technical effects.

In the quick detaching mechanism of the center shaft of the photographic tripod provided by the present disclosure, the first shaft segment 1 thereof has the clamping portions 121, the second shaft segment 2 has the locking shaft 231 which can be inserted into the first shaft segment 1, the end of the locking shaft 231 has the buckle blocks 2311, and the buckle blocks 2311 and the clamping portions 121 are clamped to lock the first shaft segment 1 and the second shaft segment 2 together. The second shaft segment 2 further includes a locking member 232, and the locking member 232 holds, in the locked state, the locking shaft 231 in the position of being locked together with the first shaft segment 1. The quick detaching mechanism may realize quick detachment and installation, at the same time, the first shaft segment 1 and the second shaft segment 2 are firmly locked by the locking member 232 in the locked state, and thus the stability and reliability of the connection may be ensured. When the adjusting member 31 performs locking or unlocking, the adjusting member 31 enters or is removed from the set height mainly by pressing the adjusting member 31 to apply a force. At this time, the second shaft segment 2 is provided with the groove 211 etc. for fixing the connecting member 33, which in turn enables it to enter or rotate out of the groove 211 by rotation, and by utilizing the connecting member 33, the locking or unlocking of the adjusting member 31 on the second shaft segment 2 is realized.

In the description of the present disclosure, it needs to be understood that orientations or position relationships indicated by orientation words such as “front, rear, up, down, left, right”, “lateral, vertical, perpendicular, horizontal” and “top, bottom” are orientations or position relationships shown based on the accompanying drawings, and are used only for facilitating the description of the present disclosure and for simplifying the description, rather than indicating or implying that a mentioned apparatus or element must have a particular orientation or must be constructed and operated in a particular orientation in the absence of any indication to the contrary, thus cannot be understood as a limitation on the scope of protection of the present disclosure. Orientation words “inside and outside” refer to inside and outside with respect to contours of parts themselves.

For ease of description, spatially relative terms such as “on . . . ”, “above . . . ”, “on the upper surface of . . . ”, “over”, etc., may be used here to describe the spatial position relationship of one device or feature to other devices or features as shown in the figures. It should be understood that the spatially relative terms are intended to contain different orientations in use or operation in addition to the orientation of the device as described in the figures. For example, if the device in the accompanying drawing is inverted, the device described as “above” or “on” the other device or configuration will later be positioned as “below” or “under” the other device or configuration. Thus, the exemplary term “above . . . ” may include two orientations “above . . . ” and “below . . . ”. The device may also be positioned in other different ways (rotated 90 degrees or in other orientations) and the spatially relative descriptions used herein are interpreted accordingly.

In addition, it needs to be noted that the use of terms such as “first” and “second” to qualify the parts is for the purpose of facilitating the differentiation of the corresponding parts, and the above words do not have special meanings if not otherwise declared, and therefore cannot be construed as a limitation of the scope of protection of the present disclosure.

The foregoing descriptions are only preferred embodiments of the present disclosure and are not used to limit the present disclosure. For those skilled in the art, the present disclosure can have various modifications and changes. Any modification, equivalent replacement, improvement, etc. made within the spirit and principle of the present disclosure should be included in the scope of protection of the present disclosure.

What is claimed is:

1. A center shaft of a photographic tripod, comprising a first shaft segment and a second shaft segment which are detachably connected; wherein
the first shaft segment has a clamping portion, the second shaft segment has a locking shaft which can be inserted into the first shaft segment, an end of the locking shaft has a buckle block, and the buckle block and the clamping portion are clamped to lock the first shaft segment and the second shaft segment together; and
the second shaft segment further comprises a locking member, and the locking member holds, in a locked state, the locking shaft in a position of being locked together with the first shaft segment.

2. The center shaft of the photographic tripod according to claim 1, wherein the first shaft segment comprises a first outer tube and a first liner member fixed in the first outer tube; and
the clamping portion is formed in the first liner member.

3. The center shaft of the photographic tripod according to claim 2, wherein a bottom face of the clamping portion is a bevel which gradually rises from bottom to top in a clamping direction.

4. The center shaft of the photographic tripod according to claim 1, wherein the clamping portion is formed in the first shaft segment and is a plane.

5. The center shaft of the photographic tripod according to claim 4, wherein the buckle block is a projection arranged at the end of the locking shaft.

6. The center shaft of the photographic tripod according to claim 1, wherein the second shaft segment comprises a second outer tube and a second liner member fixed in the second outer tube, the locking shaft penetrates in the second liner member, and the locking shaft can be slidably installed in the second liner member in an axial direction of the locking shaft.

7. The center shaft of the photographic tripod according to claim 1, wherein the locking shaft can be slidably installed in the second shaft segment in an axial direction of the locking shaft.

8. The center shaft of the photographic tripod according to claim 6, wherein the second shaft segment is provided with a boss, and a lower end of the first shaft segment is arranged as a sleeving opening for sleeving with the boss.

9. The center shaft of the photographic tripod according to claim 1, wherein one end of the locking member is pivotally connected to one end of the locking shaft away from the buckle block.

10. The center shaft of the photographic tripod according to claim 1, wherein the first shaft segment and the second shaft segment are polygonal or circular.

11. The center shaft of the photographic tripod according to claim 1, wherein the first shaft segment and the second shaft segment are polygonal, in an unlocked state of the first shaft segment and the second shaft segment, side faces of the first shaft segment and the second shaft segment are misaligned, and in a locked state of the first shaft segment and the second shaft segment, the side faces of the first shaft segment and the second shaft segment are aligned.

12. A center shaft of a photographic tripod, comprising a first shaft segment and a second shaft segment which are detachably connected, wherein a quick detaching mechanism is arranged between the first shaft segment and the second shaft segment;
the quick detaching mechanism comprises a clamping portion formed in the first shaft segment, and a locking shaft arranged on the second shaft segment, and the locking shaft can be inserted into the first shaft segment;
an end of the locking shaft has a buckle block, and the buckle block and the clamping portion are clamped to lock the first shaft segment and the second shaft segment together; and
one end of the first shaft segment or the second shaft segment away from the quick detaching mechanism is provided with an adjusting member, the adjusting member is provided with an unlocking assembly, and the unlocking assembly is configured to unlock the adjusting member from the first shaft segment or the second shaft segment.

13. The center shaft of the photographic tripod according to claim 12, wherein the first shaft segment or the second shaft segment internally has a cavity; and
the unlocking assembly comprises a body having an assembly cavity, and a connecting member located in the assembly cavity, and the connecting member is clamped in the cavity after partially extending out of the assembly cavity.

14. The center shaft of the photographic tripod according to claim 13, wherein a rotary sliding rail and a moving rail are arranged in the assembly cavity, and the moving rail extends inwards to form a bearing platform of the connecting member.

15. The center shaft of the photographic tripod according to claim 14, wherein when the adjusting member is in a set position of the assembly cavity, the connecting member is locked in the cavity, when the adjusting member is forced out of the set position, the adjusting member and the connecting member enter the rotary sliding rail of the assembly cavity, the adjusting member is rotated, the connecting member rotates along the assembly cavity, and the body, the connecting member, and the adjusting member are removed from the cavity to realize unlocking.

16. The center shaft of the photographic tripod according to claim 15, wherein the unlocking assembly further comprises an assembly member which extends into the connecting member to be connected to the adjusting member, a cover plate is connected to a top of the body, and the assembly member is located under the cover plate.

17. The center shaft of the photographic tripod according to claim 16, wherein an inner wall of the connecting member extends inwards to form a bearing ring for a head of the assembly member; and
the unlocking assembly further comprises a reset assembly which is arranged on the assembly member in a sleeving mode and located below the bearing ring.

18. The center shaft of the photographic tripod according to claim 14, wherein an assembly portion with an accommodation cavity is formed on an adjusting member upper portion, and a sliding block which moves along the connecting member and the adjusting member in the connecting member is formed on a periphery of the assembly portion; and
a lower part of the assembly cavity extends outwards to form a step-shaped structure, and the rotary sliding rail is formed in the step-shaped structure.

19. The center shaft of the photographic tripod according to claim 13, wherein the cavity and the connecting member are respectively provided with a groove and a locking block, and the locking block and the groove form a clamping fit.

20. The center shaft of the photographic tripod according to claim 13, wherein an inner wall of the assembly cavity is provided with a locking cavity for accommodating passage of a locking block.
